(19) United States
(12) Patent Application Publication
(10) Pub. No.: US 2017/0176324 A1
(43) Pub. Date: Jun. 22, 2017

(54) Parallel Optical Measurement System With Broadband Angle Selective Filters

(71) Applicant: Halliburton Energy Services, Inc., Houston, TX (US)

(72) Inventors: David L. Perkins, The Woodlands, TX (US); James M. Price, Spring, TX (US)

(73) Assignee: Halliburton Energy Services, Inc., Houston, TX (US)

(21) Appl. No.: 15/129,553

(22) PCT Filed: Apr. 15, 2015
(86) PCT No.: PCT/US2015/025922

§ 371 Date: Sep. 27, 2016

(51) Int. Cl. G01N 21/25; G01N 21/31

(52) U.S. Cl. CPC G01N 21/251; G01N 21/31; G01N 2201/0683

(57) ABSTRACT

An optical computing device includes a light source that emits electromagnetic radiation into an optical train extending from the light source to a detector. A substance optically interacts with the electromagnetic radiation. A processor array is positioned in the optical train and includes a plurality of integrated computational element (ICE) cores that optically interact with the electromagnetic radiation, wherein the detector receives modified electromagnetic radiation generated through optical interaction of the electromagnetic radiation with the substance and the processor array. A weighting array is positioned in the optical train and includes a plurality of weighting devices that optically apply corresponding weighting factors to the modified electromagnetic radiation. A broadband angle selective filter (BASF) array is positioned in the optical train to selectively pass electromagnetic radiation at a predetermined angle of incidence. The detector generates an output signal indicative of a characteristic of the substance.

### BACKGROUND

Optical computing devices, also commonly referred to as “opticoanalytical devices,” can be used to analyze and monitor substances in real time. Such optical computing devices will often employ a light source that emits electromagnetic radiation to optically interact with (i.e., reflects from, transmitted through, etc.) a sample substance and an optical processing element to determine quantitative and/or qualitative values of one or more physical or chemical properties of the substance. The optical processing element may be, for example, an integrated computational element (ICE) core, also known as a multivariate optical element (MOE). ICE cores are designed to operate over a continuum of wavelengths in the electromagnetic spectrum from the UV to mid-infrared (MIR) ranges, or any sub-set of that region. Electromagnetic radiation that optically interacts with the sample substance is changed and processed by the ICE core to be measured by a detector, and outputs from the detector can be correlated to the physical or chemical property of the substance being analyzed.

In some configurations, multiple ICE cores may be used in an optical computing device to detect a particular characteristic or analyte of interest in the substance. The optical responses from each ICE core are sequentially measured by a single detector, and an associated signal processor computationally combines the several responses using coded software such that a linear combination of the responses is obtained and correlated to the analyte of interest. Computationally combining the responses can include determining a weighted average of the various responses in order to obtain the best measurement of the analyte of interest. Since these measurements and computations are performed sequentially, this process takes time.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 illustrates an exemplary integrated computation element core.

FIG. 2 illustrates an exemplary optical computing device for analyzing a substance.

FIG. 3 illustrates another exemplary optical computing device for analyzing a substance.

### DETAILED DESCRIPTION

The present disclosure relates to optical computing devices and, more particularly, to optical computing devices that employ improved optical processing element configurations used to make parallel measurements of sample substances. The optical computing devices described herein further include broadband angle selective filters to reduce optical cross-talk between non-axially aligned optical components.

The embodiments described herein employ various configurations of optical computing devices for the real-time or near real-time monitoring of a sample substance. The optical computing devices described herein optically and otherwise physically apply weighting factors to derived response signals, as opposed to digitally applying the weighting factors using a signal processor and associated software applications. As a result, neural network or linear combinatorial methods of optical measurements may be made in parallel rather than sequentially, thereby resulting in faster sampling times. One disclosed optical computing device includes an array of optical processing elements having various weighting factors applied directly thereto. The array provides a detector with a modified optical signal already having weighting factors applied thereto. Another disclosed optical computing device includes an array of optical processing elements and a dynamic array of weighting devices optically coupled to the array of optical processing elements. The dynamic array of weighting devices may selectively change the weighting factors applied to each optical processing element in real-time, thereby allowing the optical processing element array to detect and otherwise analyze multiple analytes simultaneously over broadband wavelength.

The optical computing devices described herein may also employ broadband angle selective filters (BASF) to improve the performance of array-based optical computing devices. BASF reduces or eliminates cross-talk from stray light in such array-based optical computing devices, and reducing cross-talk improves accuracy and sensitivity performance. The BASF is placed in the optical train of the optical computing device and operates to selectively transmit a wide range of electromagnetic radiation at a designed or predetermined angle of incidence. Electromagnetic radiation that impinges upon the BASF at an angle offset from the predetermined angle of incidence is reflected and otherwise prevented from propagating along the optical train. As a result, the BASF may improve the performance of optical computing devices by reducing or eliminating optical cross-talk between non-axially aligned components in the optical component arrays.

As used herein, the term “characteristic” or “characteristic of interest” refers to a chemical, mechanical, or physical property of a substance or a sample of the substance. The characteristic of a substance may include a quantitative or qualitative value of one or more chemical constituents or compounds present therein or any physical property associated therewith. Such chemical constituents and compounds may be referred to herein as “analytes.” Illustrative characteristics of a substance that can be detected with the optical computing devices described herein can include, for example, chemical composition (e.g., identity and concentration in total or of individual components), phase presence (e.g., gas, oil, water, etc.), impurity content, pH, alkalinity, viscosity, density, ionic strength, total dissolved solids, salt content (e.g., salinity), porosity, opacity, bacteria content, total hardness, transmittance, combinations thereof, state of matter (solid, liquid, gas, emulsion, mixtures thereof, etc.), and the like.

As used herein, the term “substance,” or variations thereof, refers to at least a portion of matter or material of interest to be tested or otherwise evaluated using the optical computing devices described herein. The substance includes the characteristic of interest, as defined above. The substance may be any fluid capable of flowing, including particulate solids, liquids, gases (e.g., air, nitrogen, carbon dioxide, argon, helium, methane, ethane, butane, and other hydrocarbon gases, hydrogen sulfide, and combinations thereof), slurries, emulsions, powders, muds, glasses, mixtures, combinations thereof, and may include, but is not limited to, aqueous fluids (e.g., water, brines, etc.), non-aqueous fluids (e.g., organic compounds, hydrocarbons, oil, a refined component of oil, petrochemical products, and the like), acids, surfactants, biocides, bleaches, corrosion inhibitors, foamers and foaming agents, breakers, scavengers, stabilizers, clarifiers, detergents, treatment fluids, fracturing fluids, formation fluids, or any oilfield fluid, chemical, or substance commonly found in the oil and gas industry. In some cases, the substance may also refer to a solid material such as, but not limited to, rock formations, concrete, solid wellbore surfaces, pipes or flow lines, and solid surfaces of any wellbore tool or projectile (e.g., balls, darts, plugs, etc.).

As used herein, the term “electromagnetic radiation” refers to radio waves, microwave radiation, terahertz, infrared and near-infrared radiation, visible light, ultraviolet light, X-ray radiation and gamma ray radiation.

As used herein, the term “optically interact” or variations thereof refers to the reflection, transmission, scattering, diffraction, or absorption of electromagnetic radiation either on, through, or from one or more processing elements (i.e., an optical processing device), a substance being analyzed by the processing elements, or a polarizer. Accordingly, optically interacted light refers to electromagnetic radiation that has been reflected, transmitted, scattered, diffracted, or absorbed by, emitted, or re-radiated, for example, using a processing element, but may also apply to optical interaction with a substance or a polarizer.

As used herein, the terms “optically coupled” and “optically aligned” are used interchangeably and refer to axially and optically aligning optical components of an optical computing device along the optical train of the optical computing device. When optical components of an optical computing device are optically coupled or aligned, for example, electromagnetic radiation that optically interacts with one element of a first optical component array is able to optically communicate with a co-axially aligned element of a second optical component array while a substance is being analyzed.

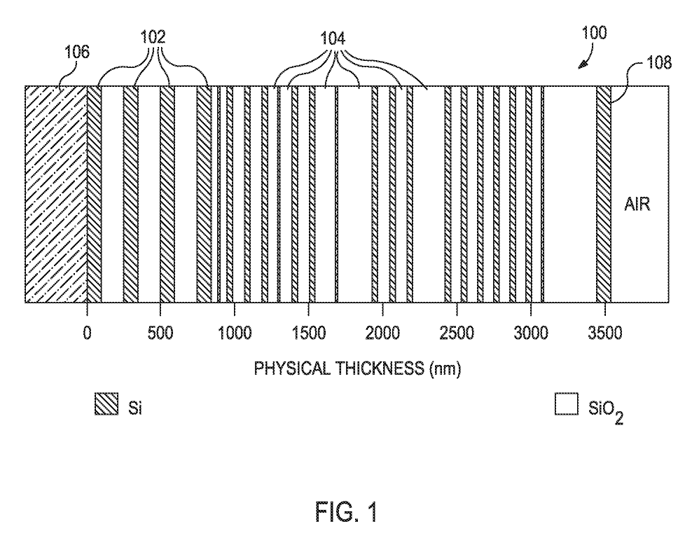

The optical computing devices described herein may employ one or more integrated computational element (ICE) cores. In operation, an ICE core is designed to distinguish electromagnetic radiation related to a characteristic of interest of a substance from electromagnetic radiation related to other components of the substance. With reference to FIG. 1, illustrated is an exemplary ICE core 100 that may be used in the systems described herein. As illustrated, the ICE core 100 may include a plurality of alternating thin film layers 102 and 104, such as silicon (Si) and SiO₂ (quartz), respectively. In general, these layers 102, 104 consist of materials whose index of refraction is high and low, respectively. Other examples of materials might include niobia and niobium, germanium and germania, MgF, SiO, and other high and low index materials known in the art. The layers 102, 104 may be strategically deposited on an optical substrate 106. In some embodiments, the optical substrate 106 is BK-7 optical glass. In other embodiments, the optical substrate 106 may be another type of optical substrate, such as another optical glass, silica, sapphire, silicon, germanium, zinc selenide, zinc sulfide, or various plastics such as polycarbonate, polymethylmethacrylate (PMMA), polyvinylchloride (PVC), diamond, ceramics, combinations thereof, and the like.

At the opposite end (e.g., opposite the optical substrate 106 in FIG. 1), the ICE core 100 may include a layer 108 that is generally exposed to the environment of the device or installation, and may be able to optically interact with a sample substance. The number of layers 102, 104 and the thickness of each layer 102, 104 are determined from the spectral attributes acquired from a spectroscopic analysis of a characteristic of the substance being analyzed using a conventional spectroscopic instrument. The spectrum of interest of a given characteristic typically includes any number of different wavelengths.

It should be understood that the ICE core 100 depicted in FIG. 1 does not in fact represent any particular ICE core used to detect a specific characteristic of a given substance, but is provided for purposes of illustration only. Consequently, the number of layers 102, 104 and their relative thicknesses, as shown in FIG. 1, bear no correlation to any particular substance or characteristic thereof. Nor are the layers 102, 104 and their relative thicknesses necessarily drawn to scale, and therefore should not be considered limiting of the present disclosure.

In some embodiments, the material of each layer 102, 104 can be doped or two or more materials can be combined in a manner to achieve the desired optical characteristic. In addition to solids, the exemplary ICE core 100 may also contain liquids and/or gases, optionally in combination with solids, in order to produce a desired optical characteristic. In the case of gases and liquids, the ICE core 100 can contain a corresponding vessel (not shown), which houses the gases or liquids. Exemplary variations of the ICE core 100 may also include holographic optical elements, gratings, piezoelectric, light pipe, and/or acousto-optic elements, for example, that can create transmission, reflection, and/or absorptive properties of interest.

The multiple layers 102, 104 may exhibit different refractive indices. By properly selecting the materials of the layers 102, 104 and their relative thickness and spacing, the ICE core 100 may be configured to selectively transmit or reflect predetermined fractions of electromagnetic radiation at different wavelengths. Each wavelength is given a predetermined weighting or loading factor. The thickness and spacing of the layers 102, 104 may be determined using a variety of approximation methods from the spectrum of the characteristic or analyte of interest. These methods may include inverse Fourier transform (IFT) of the optical transmission spectrum and structuring the ICE core 100 as the physical representation of the IFT. The approximations convert the IFT into a structure based on known materials with constant refractive indices.

The weightings that the layers 102, 104 of the ICE core 100 apply at each wavelength may be set to the regression weightings described with respect to a known equation, data, or spectral signature. For instance, when electromagnetic radiation interacts with a substance, unique physical and chemical information about the substance is encoded in the electromagnetic radiation that is reflected from, transmitted through, or radiated from the substance. This information is often referred to as the spectral “fingerprint” of the substance. The ICE core 100 may be configured to perform the dot product of the received electromagnetic radiation and the wavelength dependent transmission function of the ICE core 100. The wavelength dependent transmission function of the ICE core 100 is dependent on the material refractive index of each layer, the number of layers 102, 104 and thickness of each layer 102, 104.

One type or variation of an ICE core 100 is a frequency selective surface (FSS) ICE core. The FSS ICE core is similar in some respects to the ICE core 100 described above, but instead of having a stack of dielectric thin film layers 102, 104, an FSS ICE core includes a single, periodically-patterned metallic thin film layer. Upon optically interacting with electromagnetic radiation, the FSS ICE core generates an optical processing function that is dependent on the shape of the FSS structure, the type of metal used for the thin film layer, and the thickness of the metal layer.

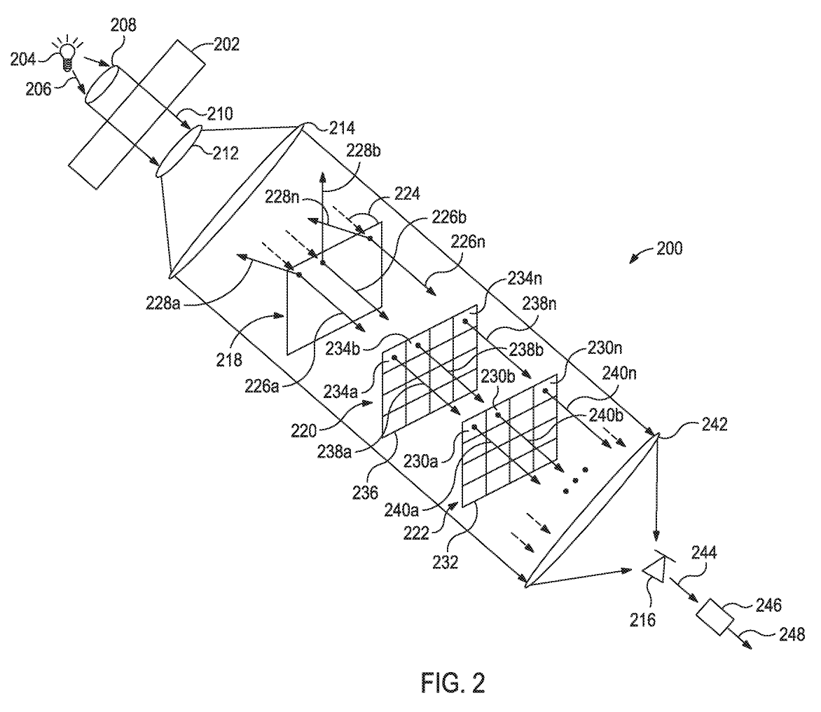

Referring now to FIG. 2, illustrated is an exemplary optical computing device 200 (hereafter “the device 200”) that may be used in analyzing a substance 202, according to one or more embodiments. The device 200 may be configured to determine a characteristic of the substance 202, such as the concentration of a particular analyte of interest present therein. In some embodiments, the substance 202 may be contained in a fluid sampling chamber or the like. In other embodiments, the substance 202 may be a fluid flowing within a flow line, a pipeline, a wellbore, an annulus defined within a wellbore, or any flow lines or pipelines extending to/from a wellbore. In yet other embodiments, the substance 202 may be disposed within any other containment or storage vessel known to those skilled in the oil and gas industry. It is contemplated herein that the device 200 may be used under laboratory conditions as well as in conjunction with field applications, without departing from the scope of the disclosure.

The device 200 includes a light source 204 configured to emit or otherwise generate electromagnetic radiation 206. The light source 204 may be, for example, a light bulb, a light emitting diode (LED), a laser, a blackbody, a photonic crystal, an X-Ray source, a supercontinuum source, combinations thereof, or the like. In some embodiments, a first collimator 208 may be configured to collect or otherwise receive the electromagnetic radiation 206 and direct a collimated beam of electromagnetic radiation 206 toward the substance 202. In other embodiments, the first collimator 208 may be omitted from the device 200 and the electromagnetic radiation 206 may instead be directed toward the substance 202 directly from the light source 204.

In the illustrated embodiment, the electromagnetic radiation 206 is transmitted through the substance 202 where it optically interacts with the substance 202, including any analytes present within the substance 202. As a result, sample interacted radiation 210 is generated by the substance 202 and conveyed further downstream within the optical train. Alternatively, the sample interacted radiation 210 may be generated by being reflected, scattered, diffracted, absorbed, emitted, or re-radiated by and/or from the substance 202, without departing from the scope of the disclosure.

In at least one embodiment, the sample interacted radiation 210 is generated by an evanescent wave, which may be generated through attenuated total reflectance (ATR) sampling techniques known to those skilled in the art. More particularly, evanescent waves are formed when light waves or beams traveling in a medium (e.g., an ATR crystal or the like) undergo total internal reflection at the boundaries of the medium because they strike the boundaries at an angle greater than the “critical” angle. An evanescent wave is subsequently produced from the medium and directed toward a sample (i.e., the substance 202), and the interaction of the evanescent wave with the sample induces absorption and allows for spectroscopic interrogation of the sample.

In some embodiments, the sample interacted radiation 210 generated by interaction with the substance 202 may be directed to or otherwise received by an expander 212, also known as a “beam expander.” The expander 212 may be any device capable of expanding the size of a beam of light, such as the sample interacted radiation 210. A second collimator 214 may be arranged within the optical train to receive and collimate the sample interacted radiation 210 received from the expander 212. Similar to the first collimator 208, the second collimator 214 may produce a substantially collimated or parallel beam of electromagnetic radiation.

The second collimator 214 may be configured to convey the sample interacted radiation 210 toward a detector 216 within the optical train of the device 200. As used herein, the term “optical train” refers to the light path extending from the light source 204 to the detector 216 and encompassing or otherwise traversing any optical components of the device 200 positioned therebetween. In the illustrated embodiment, the optical components of the device 200 include at least one or more of, but are not limited to, a broadband angle selective filter (BASF) array 218, a weighting array 220, and a processor array 222. In some embodiments, as discuss below, the weighting array 220 may be monolithically formed with the processor array 222. In other embodiments, the weighting array 220 may be entirely omitted from the device 200, without departing from the scope of the disclosure.

The BASF array 218 may comprise an optical element that reduces or substantially eliminates optical cross-talk within the optical train, and thereby enhances the performance of the device 200 in measuring characteristics of the substance 202. The BASF array 218 may be made of a plurality of layers of materials, such as a series of quarter-wave heterostructures of photonic crystals or metamaterials. The BASF array 218 may be designed and otherwise configured to allow transmission of light (e.g., electromagnetic radiation 206, sample interacted radiation 210, etc.) that impinges upon the BASF array 218 at a predetermined angle of incidence 224, while simultaneously reflecting light that impinges upon the BASF array 218 at an angle offset from the predetermined angle of incidence 224. In the illustrated embodiment, the predetermined angle of incidence 224 for the BASF array 218 is substantially orthogonal to the plane of the BASF array 218, where “substantially orthogonal” encompasses angles of incidence ranging from about 85° to about 95° from the plane of the BASF array 218. In other embodiments, the predetermined angle of incidence 224 may be orthogonal to the axis of the optical train and otherwise encompass any angle from the plane of the BASF array 218. Accordingly, the predetermined angle of incidence 224 may depend on the structural configuration of the BASF array 218 and its particular structural orientation in the optical train. In yet other embodiments, the BASF array 218 may be rotatable about a central axis to selectively and/or dynamically determine the predetermined angle of incidence 224.

In the illustrated embodiment, the sample interacted radiation 210 propagating from the second collimator 214 and impinging upon the BASF array 218 at the predetermined angle of incidence 224 may pass therethrough as angle selective radiation 226 (shown as beams of angle selective radiation 226a, 226b, . . . , and 226n). In contrast, the sample interacted radiation 210 that impinges upon the BASF array 218 at any angle offset from the predetermined angle of incidence 224 may be prevented from passing through the BASF array 218 and is otherwise reflected from the BASF array 218 as reflected radiation 228 (shown as reflected radiation 228a, 228b, . . . , and 228n). Accordingly, the BASF array 218 may prove advantageous in eliminating or substantially eliminating beams of light within the optical train that are offset from the predetermined angle of incidence 224, which may result in the reduction of optical cross-talk along the optical train.

The angle selective radiation 226a-n may be conveyed toward the weighting array 220 and the processor array 222 to optically interact therewith. The processor array 222 may include several ICE cores 230 (shown as ICE cores 230a, 230b, . . . and 230n) strategically and individually arranged on a substrate 232. The substrate 232 may be any optical substrate including, but not limited to, optical glass (e.g., BK-7 optical glass), quartz, sapphire, silicon, germanium, zinc selenide, zinc sulfide, or various plastics such as polycarbonate, polymethylmethacrylate (PMMA), polyvinylchloride (PVC), diamond, ceramics, combinations thereof, and the like.

Each ICE core 230a-n may be an optical processing device similar to the ICE core 100 described above with reference to FIG. 1. In other embodiments, the ICE cores 230a-n may be any other type of optical processing device, such as an FSS ICE core described above. As depicted, the ICE cores 230a-n are separately and individually arranged on the substrate 232 in a square four row by four-column matrix. The ICE cores 230a-n, however, may alternatively be arranged in any predetermined pattern or sequence, without departing from the scope of the disclosure. Moreover, the processor array 222 and associated substrate 232 does not necessarily have to be square, but could likewise be formed in any polygonal shape (e.g., rectangular, hexagonal, pentagonal, linear, etc.), or may alternatively be circular, oval, or ovoid in shape, without departing from the scope of the disclosure.

While a certain number of ICE cores 230a-n are depicted as arranged on the substrate 232, those skilled in the art will readily recognize that more or less ICE cores 230a-n than those depicted may be employed in the device 200. Each ICE core 230a-n arranged on the substrate 232 may be configured to detect a particular characteristic of the substance 202. In some embodiments, two or more of the ICE cores 230a-n may be configured to detect the same characteristic of the substance 202. In other embodiments, however, each ICE core 230a-n may be configured to detect a different or distinct characteristic.

One or more of the ICE cores 230a-n has a weighting factor associated therewith. In some embodiments, for example, the weighting factor may be applied directly to the ICE cores 230a-n in the form of a weighting device that forms an integral part of the given ICE cores 230a-n. In other embodiments, as illustrated, the weighting factor may be applied to the one or more ICE cores 230a-nvia the weighting array 220, which may comprise a plurality of weighting devices 234 (depicted as weighting devices 234a, 234b, . . . , and 234n) strategically arranged on a weighting substrate 236. The weighting substrate 236 may be similar to the substrate 232, and therefore will not be described again.

The weighting array 220 may be optically coupled to the processor array 222. More particularly, the weighting devices 234a-n may be individually and separately arranged on the weighting substrate 236 such that each axially and optically aligns with a corresponding one of the ICE cores 230a-n. In the illustrated embodiment, the weighting devices 234a-n are arranged on the weighting substrate 236 in a four-by-four square matrix, such that the first weighting device 234a is optically aligned with the first ICE core 230a, the second weighting device 234b is optically aligned with the second ICE core 230b, and so on until the n^{th} weighting device 234n is optically aligned with the n^{th} ICE core 230n. As a result, the number of ICE cores 230a-n may generally be the same as the number of weighting devices 234a-n. Moreover, any changes to the structural configuration of the processor array 222 may be substantially mimicked by the weighting array 220 such that co-axial ICE cores 230a-n and weighting devices 234a-n remain optically coupled, meaning that they remain axially and optically aligned within the optical train while the substance 202 is being analyzed.

The weighting devices 234a-n may be configured to reduce the intensity of light (e.g., electromagnetic radiation 206, sample interacted radiation 210, etc.) propagating along the optical train by a predetermined or specific quantity. Suitable weighting device 234a-n may include, but are not limited to, a neutral density filter, an optical iris, a pinhole, an aperture, or any combination thereof. Each weighting device 234a-n acts as a broadband neutral density filter that has a particular and predetermined weighting factor associated therewith. For instance, in at least one embodiment, the weighting devices 234a-n may each comprise a neutral density filter that exhibits a particular weighting factor configured to reduce the normalized intensity of the optical responses of each ICE core 230a-n ranging from 0 to 1, where 0 is a minimum intensity of light transmitted, and 1 is the maximum intensity of light transmitted. Depending on the design and configuration of the given weighting device 234a-n, a particular static weighting factor is applied to the ICE cores 230a-n to alter the output signal of the corresponding ICE cores 230a-n to a particular or predetermined characteristic or analyte of interest. As a result, the intensity of the optical response from each ICE core 230a-n may be reduced and otherwise affected by the corresponding weighting device 234a-n, thereby resulting in a weighted output that can be tailored to the characteristic of interest.

The processor array 222 and the weighting array 220 are depicted in FIG. 2 as being axially offset from each other by a short distance. While the processor array 222 and the weighting array 220 may be arranged at any axial offset distance from each other, it may prove advantageous to arrange the processor array 222 and the weighting array 220 fairly close to each other and otherwise substantially adjacent one another. Doing so may have the effect of avoiding or otherwise mitigating optical cross talk of ICE cores 230a-n with the wrong (not axially adjacent) weighting devices 234a-n. Accordingly, the exploded view of the processor array 222 and the weighting array 220 is depicted merely for illustrative purposes and therefore is not to be considered as limiting the scope of the disclosure. In some embodiments, the position of the processor array 222 and the weighting array 220 in the optical train may be switched. Moreover, in at least one embodiment, the processor array 222 and the weighting array 220 may alternatively be integrally formed as a monolithic structure, without departing from the scope of the disclosure.

In exemplary operation, the weighting array 220 and the processor array 222 may receive and optically interact with the light (e.g., electromagnetic radiation 106, sample interacted radiation 210, etc.) propagating within the optical train. More specifically, and in view of FIG. 2, the weighting array 220 and the processor array 222 may receive and optically interact with the angle selective radiation 226a-n emitted by the BASF array 218. Each weighting device 234a-n of the weighting array 220 may optically interact with the angle selective radiation 226a-n and thereby generate corresponding optical responses 238 (shown as optical responses 238a, 238b, . . . , and 238n). Each optical response 238a-n may then be received by a corresponding one of ICE cores 230a-n arranged on the processor array 222 and optically aligned therewith. More particularly, the first optical response 238a may be received by the first ICE core 230a, the second optical response 238b may be received by the second ICE core 230b, and the n^{th} optical response 238n may be received by the n^{th} ICE core 230n.

Each ICE core 230a-n optically interacts with the optical responses 238a-n and generates corresponding beams of modified electromagnetic radiation 240 (shown as modified electromagnetic radiation 240a, 240b, . . . , and 240n). Each beam of modified electromagnetic radiation 240a-n is electromagnetic radiation that has optically interacted with its corresponding weighting device 234a-n and ICE core 230a-n (if applicable), whereby an approximation of the regression vector corresponding to the characteristic of the substance 202 associated with the respective ICE core 230a-n is computed and otherwise obtained.

The modified electromagnetic radiation 240a-n may then be directed to an optical focusing element 242 arranged within the optical train. The optical focusing element 242 may be any type of optical element capable of focusing the modified electromagnetic radiation 240a-n toward a focal point. The optical focusing element 242 may be similar to the expander 212, except used in reverse to reduce the size of a beam of light. The optical focusing element 242 focuses the beams of modified electromagnetic radiation 240a-n toward the detector 216 for integrating the several optical responses from the ICE cores 230a-n. In some embodiments, the optical focusing element 242 may be omitted from the device 200 and the individual beams of modified electromagnetic radiation 240a-n may be received by the detector 216 or a plurality of detectors optically aligned with each beam of modified electromagnetic radiation 240a-n.

The detector 216 may be any device capable of detecting electromagnetic radiation, and may be generally characterized as an optical transducer. Suitable detectors 216 include, but are not limited to, a thermal detector such as a thermopile or photoacoustic detector, a semiconductor detector, a piezo-electric detector, a charge coupled device (CCD) detector, a video or array detector, a split detector, a photon detector (such as a photomultiplier tube), photodiodes, combinations thereof, or the like, or other detectors known to those skilled in the art.

The detector 216 may produce an output signal 244 in real-time or near real-time in the form of a voltage (or current) that corresponds to a particular characteristic of interest in the substance 202. The voltage returned by the detector 216 is essentially the dot product of the optical interaction of the sample interacted radiation 210 with the respective ICE cores 230a-n as a function of the magnitude of the characteristic of the substance 202, such as analyte concentration. As such, the output signal 244 produced by the detector 216 and the concentration of the characteristic may be directly proportional. In other embodiments, however, the relationship may correspond to a polynomial function, an exponential function, a logarithmic function, and/or a combination thereof.

The output signal 244 may be conveyed to or otherwise received by a signal processor 246 communicably coupled to the detector 216. The signal processor 246 may be a computer including a processor and a machine-readable storage medium having instructions stored thereon, which, when executed by the processor, cause the device 200 to perform a number of operations, such as determining a characteristic of the substance 202. For instance, the concentration of the characteristic detected with the device 200 can be fed into an algorithm operated by the signal processor 246, and the algorithm can be part of an artificial neural network that uses the concentration of the detected characteristic to evaluate the overall quality of the substance 202.

In real-time or near real-time, the signal processor 246 may be programmed to provide a resulting output signal 248 corresponding to the characteristic of interest in the substance 202 as cooperatively measured by the several ICE cores 230a-n. Advantageously, since the weighting factors are already applied to the ICE cores 230a-n via the weighting devices 234a-n of the weighting array 220, the detector 216 automatically receives the weighted average of the modified electromagnetic radiation 240a-n and the output signal 244 generated therefrom is indicative of the same. As a result, the signal processor 246 is not required to digitally apply the weighting factors to the signals derived from each ICE core 230a-n. Rather, the weighting factors are physically and/or optically applied to the resulting output signal 248 as the sample interacted radiation 210 (e.g., the angle selective radiation 226a-n ) optically interacts with the weighting devices 234a-n positioned on the weighting array 220.

As further explanation, in prior optical computing devices, a characteristic of the substance 202 would typically be identified by sequentially combining the outputs of several ICE cores in the signal processor 246. The optical outputs from each ICE core would be measured sequentially and a linear combination of these outputs as generated by the signal processor 246 would be used to determine the particular characteristic of the substance 202. Mathematically, this can be done using the following equation:

Output=Σᵢ₌₁ⁿWᵢ∫Aᵢ(λ)Iᵢ(λ)dλ Equation (1)

where Wᵢ is a weighting factor to be applied digitally in the signal processor 246, Aᵢ(λ) is the optical transmission function for each ICE core, Iᵢ(λ) is the transmission spectrum of light having optically interacted with the substance 202, and n is the number of ICE cores used in the model. In traditional computational methods, the individual dot products of the optical transmission function Aᵢ(λ) and the transmission spectrum Iᵢ(λ) are generally proportional to the concentration of the characteristic of interest, and predetermined weighting factors (Wᵢ) are digitally applied to each output signal 244 in the signal processor 246 to obtain a single resulting output signal 248 corresponding to a single characteristic of interest. More particularly, the software employed by the signal processor 246 takes the several output signals 228 from the detector 216 and adds them together along with the predetermined weighting factors for each output signal 244. Accordingly, the resulting output signal 248 provides a digital representation of the weighting factors as applied to the output signals 228.

According to embodiments of the present disclosure, however, the weighting factors are applied optically (e.g., physically) to the optical responses for each ICE core 230a-n prior to reaching the detector 216, and thereby creating a new filter function (F₁). Defining the new filter function (F₁) as the weighting factor (Wᵢ) multiplied by the optical transmission function for each ICE core (A₁), Equation (1) above can be rewritten as follows:

Output=Σᵢ₌₁ⁿ∫Fᵢ(λ)Iᵢ(λ)dλ Equation (2)

where the weighting factors Wᵢ and the optical transmission functions Aᵢ(λ) for each ICE core 230a-n are combined to obtain the new filter function Fᵢ(λ). As a result, the weighting factors are applied optically to the optical responses generated by each ICE core 230a-n, instead of digitally through software manipulation carried out in the signal processor 246. Accordingly, instead of being required to measure the optical response of each ICE core 230a-n sequentially in time, and subsequently apply a weighting factor thereto digitally, the present disclosure provides a means to measure the optical response of each ICE core 230a-n in view of a predetermined weighting factor simultaneously. Moreover, mathematically, the detector 216 sees the responses simultaneously, and not in time. Therefore, the signal measured by the detector 216 already includes all the weighting factors applied thereto, and the signal processor 246 is therefore not required to subsequently apply the weighting factors during computation.

According to the present disclosure, the BASF array 218 may prove advantageous in reducing and otherwise eliminating optical cross-talk across adjacent optical channels along the optical train, such that the light (e.g., electromagnetic radiation 206, sample interacted radiation 210, angle selective radiation 226a-n, etc.) remains axially aligned while propagating toward and through the weighting array 220 and the processor array 222. As will be appreciated, optical cross-talk can arise from stray light or specular reflections originating from the light source 204 (or any light source) that are not incident on individual weighting devices 234a-n of the weighting array 220 and/or the individual ICE cores 230a-n of the processor array 222 at normal incidence. Such stray light can result in instances where a weighting device 234a-n on the weighting array 220 can inadvertently pass light toward a non-coaxially positioned ICE core 230a-n on the processor array 222 (or vice versa, depending on the configuration). In such instances, this may result in portions of light that are not properly weighted when processed by a given ICE core 230a-n. More particularly, stray light can result in a spectral shift in the optical profile of a given ICE core 230a-n, and such a spectral shift can degrade the processing performance of the given ICE core 230a-n with respect to the characteristic for which it was designed to measure and/or detect.

Those skilled in the art will readily appreciate that various structural configurations of the device 200 may be employed, without departing from the scope of the disclosure. For instance, while FIG. 2 depicts the BASF array 218, the weighting array 220, and the processor array 222 optically aligned in a particular linear combination within the optical train of the device 200, the position of any of the foregoing optical components may be switched or placed at any point along the optical train, without departing from the scope of the disclosure. For example, in one or more embodiments, the processor array 222 may be arranged within the optical train between the light source 204 and the substance 202 and equally obtain substantially the same results. Moreover, in other embodiments, the processor array 222 may generate the modified electromagnetic radiation 240 through reflection, instead of transmission.

In yet other embodiments, one or all of the first and second collimators 208, 214, the expander 212, and the optical focusing element 242 may be omitted from the device 200 or otherwise rearranged to accommodate the position of the processor array 222 in the optical train. For instance, in at least one embodiment, the expander 212 may be arranged prior to the substance 202 in the optical train such that the electromagnetic radiation 206 is expanded prior to transmission through or reflection from the substance 202.

In even further embodiments, the BASF array 218 may be positioned between or after both the weighting array 220 and the processor array 222. In some embodiments, the BASF array 218 may be coupled to and otherwise form an integral, monolithic part of the weighting array 220. Alternatively, the BASF array 218 may be coupled to and otherwise form an integral, monolithic part of the processor array 222. Those skilled in the art will recognize that various optical configurations of device 200 are possible without departing from the scope of this disclosure.

In some embodiments, the weighting array 220 may be a static component of the device 200, where the weighting devices 234a-n remain static and otherwise filter a constant amount or percentage of light during operation. In other embodiments, however, the weighting array may comprise a dynamic component of the device 200. More particularly, the weighting array 220 may be movable and otherwise selectively changeable in order to vary the weighting factors of each weighting device 234a-n in real-time for a given processor array 222. As a result, and with reference again to Equations (1) and (2) above, the weighting factors Wᵢ for the optical transmission functions Aᵢ (λ) of each ICE core 230a-n may selectively be varied, thereby resulting in a new filter function Fᵢ(λ) for each dynamic change applied to the weighting array 220.

As will be appreciated, dynamically varying the weighting array 220 may allow the device 200 to detect several characteristics of the substance 202 with a single processor array 222. For instance, in a first configuration, the weighting devices 234a-n may each exhibit a particular weighting factor and the processor array 222 may be configured to detect a first characteristic of the substance 202, such as the concentration of a first analyte. However, in a second configuration, the weighting factor of the weighting devices 234a-n may be changed such that the processor array 222 may be configured to detect a second characteristic of the substance 202, such as the concentration of a second analyte. Accordingly, the weighting factors may be dynamically changed in the weighting array 220 in order to detect or otherwise analyze any number of characteristics of the substance 202.

In some embodiments, the weighting devices 234a-n for the weighting array 220 may be or otherwise incorporate the use of adjustable optical irises having a mechanical aperture. In operation, each optical iris may be movable or changeable in real-time by an operator, thereby altering the diameter of each corresponding mechanical aperture. Each optical iris, for example, may be operatively coupled to an actuation device or the like, where the actuation device is configured to manipulate the size (i.e., diameter, opening, etc.) of the mechanical aperture. As can be appreciated, changing the size of the mechanical apertures may result in a corresponding change to the intensity of light that is able to pass through each weighting device 234a-n, and thereby selectively controlling the intensity of the modified electromagnetic radiation 240a-n. Varying the intensity of the modified electromagnetic radiation 240a-n may allow the device 200 to analyze different characteristics of the substance 202.

In other embodiments, one of the weighting array 220 and the processor array 222 may be arranged on a movable assembly (not shown). The movable assembly may be a wheel configured to rotate about a central axis and the weighting devices 234a-n may be neutral density filters, pinholes or apertures of a certain size, exhibiting corresponding predetermined weighting factors. As the movable assembly rotates, the weighting devices 234a-n are able to be optically coupled with different ICE cores 230a-n, and thereby allowing the ICE cores 230a-n to optically interact with different optical responses 238a-n. In at least one embodiment, the movable assembly may incrementally move the weighting array 220 or the processor array 222 such that individual ICE cores 230a-n are able to optically interact with more than one optical response 238a-n depending on the angular rotation of the movable assembly. As a result, several different characteristics of interest of the substance 202 may be detectable as the movable assembly rotates.

In other embodiments, the weighting array 220 may be a first weighting array arranged on the movable assembly (not shown), and the movable assembly may include at least a second or additional weighting array (not shown). The movable assembly may be configured to selectively move the first and second weighting arrays into the optical train such that each weighting array may apply a different set of weighting factors to the optical responses of the ICE cores 230a-n. As a result, the intensity of each optical response 238a-n may be selectively manipulated and otherwise altered, thereby allowing the device 200 to detect an additional or different characteristics of the substance 202. In such embodiments, the weighting devices 234a-n of each weighting array (e.g., the first and second weighting arrays) may be neutral density filters exhibiting corresponding predetermined weighting factors. Likewise, in such embodiments, the weighting devices 234a-n of each weighting array may be corresponding pinholes or apertures of a certain size exhibiting corresponding predetermined weighting factors.

In embodiments where the movable assembly is a rotatable wheel, the movable assembly may be moved such that the various weighting arrays (e.g., the first and second weighting arrays) are able to convey corresponding optical responses 238a-n to the ICE cores 230a-n at preselected intervals. In other embodiments, the movable assembly may be a linear array or structure having the various weighting arrays (e.g., the first and second weighting arrays) strategically arranged thereon. As the linear structure oscillates in a linear path, the various weighting arrays associated therewith are able to convey the optical responses 238a-n to the ICE cores 230a-n at preselected intervals.

In other embodiments, the weighting array 220 may be generally static within the optical train, but the weighting devices 234a-n associated therewith may comprise tunable filters and may otherwise be changeable in real-time by the operator. For instance, in at least one embodiment, the weighting devices 234a-n may be microelectromechanical systems (MEMS) mirrors. In other embodiments, the tunable filters may be other opto-electric filters such as, but not limited to, tunable Fabry-Perot etalons or cavities, acoustic tunable optical filters, or lithium niobate modulators. In yet other embodiments, the weighting devices 234a-n may be liquid crystal tunable filters, without departing from the scope of the disclosure. In such embodiments, the tunable weighting devices 234a-n may be selectively tuned or altered by the operator such that a predetermined weighting factor is applied at each weighting device 234a-n, and thereby controlling the intensity of the modified electromagnetic radiation 240a-n received by the detector 216.

In some embodiments, the weighting array 220 may further include an array of polarizing filters (not shown) coupled to each weighting device 234a-n or otherwise forming an integral part thereof. The polarization of the individual weighting devices 234a-n may have varying orientations. As a result, if a linear polarizer (not shown) is rotated either in front of or behind the weighting array 220 within the optical train, the intensity of the modified electromagnetic radiation 240a-n received by the detector 216 through each weighting device 234a-n will depend on the relative angular displacement of the weighting array 220 and the linear polarizer. Moreover, as will be appreciated, two polarizing films may act like a neutral density filter whose transmittance intensity changes with respect to angle. In addition, FSS based filters can be made with polarization dependent spectra. For example, an FSS ICE core can be constructed in order to be responsive to various analytes depending on the state of polarization of the incident light.

While the dynamic weighting array(s) 220 described and illustrated herein are depicted as being optically coupled to the processor array 222, it will be appreciated that the weighting array 220 may be arranged at any location along the optical path between the light source 204 and the detector 216 and obtain equally the same results. In some embodiments, for example, the weighting array 220 may be placed between the light source 204 and the substance 202. In other embodiments, the weighting array 220 may be positioned following the processor array 222 in the optical train. In further embodiments, the weighting array 220 may be a first weighting array and the device 200 may include one or more additional weighting arrays (not shown). The additional weighting arrays may be arranged at any location along the optical train (i.e., between the light source 204 and the detector 216) in order to further manipulate the intensity of the modified electromagnetic radiation 240a-n received by the detector 216. Those skilled in the art will readily recognize the several different configurations and arrangements of the weighting array 220 within device 200, without departing from the scope of the disclosure.

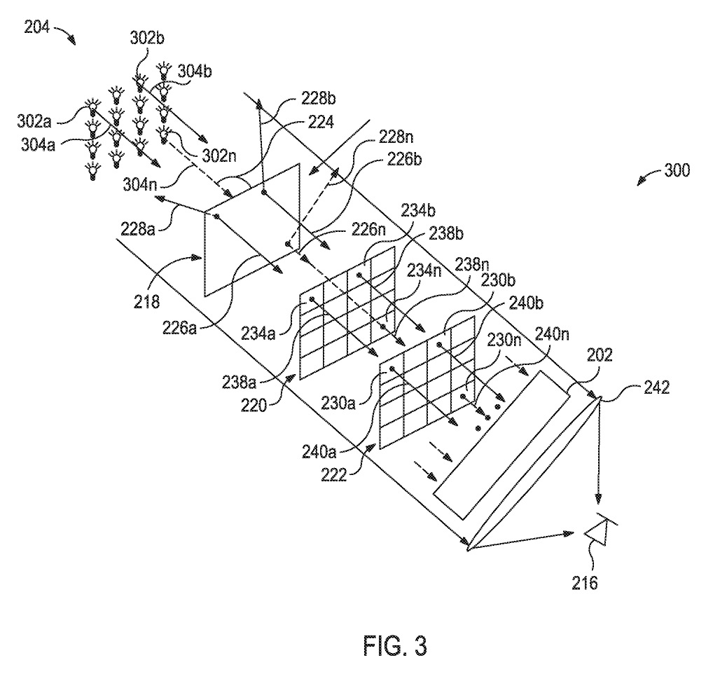

Referring now to FIG. 3, with continued reference to FIG. 2, illustrated is another exemplary optical computing device 300 (hereafter “the device 300”) that may be used in analyzing the substance 202, according to one or more embodiments. Like numerals used in FIGS. 2 and 3 represent like components that will not be described again in detail. As illustrated, the device 300 may include at least the BASF array 218 and the processor array 222, where the ICE cores 230a-n are individually arranged on the substrate 232 of the processor array 222. Moreover, the substance 202 is positioned after the BASF array 218 and the processor array 222 within the optical train, but may alternatively be positioned at any point along the optical train, without departing from the scope of the disclosure.

In some embodiments, the device 300 may further include the weighting array 220, which may or may not be monolithically formed with one of the BASF array 218 and the processor array 222. In other embodiments, however, the weighting array 220 may be omitted from the device, and the light source 204 may alternatively provide varying weighting factors for the ICE cores 230a-n. More particularly, the light source 204 may comprise a light source array that includes several individual light source elements 302 (shown as light source elements 302a, 302b, . . . , and 302n) configured to emit corresponding beams of electromagnetic radiation 304 (shown as electromagnetic radiation 304a, 304b, . . . , and 304n). Each light source element 302a-n may be optically coupled to a corresponding ICE core 230a-n. Accordingly, the first light source element 302a may be configured to provide electromagnetic radiation 304a to the first ICE core 230a, the second light source element 302bmay be configured to provide electromagnetic radiation 304b to the second ICE core 230b, and the n^{th} light source element 302n may be configured to provide electromagnetic radiation 304n to the n^{th} ICE core 230n.

In operation, the intensity of each light source element 302a-n may be dynamically adjusted or otherwise manipulated in real-time by an operator in order to alter the corresponding weighting factors for each ICE core 230a-n. As a result, the operator may be able to selectively tune each light source element 302a-n such that a predetermined weighting factor is physically and otherwise optically applied at each ICE core 230a-n, and thereby control the intensity of the modified electromagnetic radiation 240a-n that is subsequently received by the detector 216.

In embodiments where the weighting array 220 is included in the device 300, the light source elements 302a-n may be optically coupled to corresponding weighting devices 234a-n of the weighting array 220 and corresponding ICE cores 230a-n of the processor array 222. Accordingly, the first light source element 302a may be configured to provide electromagnetic radiation 304a to the first weighting device 234a and the first ICE core 230a, the second light source element 302b may be configured to provide electromagnetic radiation 304b to the second weighting device 234b and the second ICE core 230b, and so on as the n^{th} light source element 302n provides electromagnetic radiation 304n to the n^{th} weighting device 234n and the n^{th} ICE core 230n. The weighting array 220 can be either a static weighting array and allow the device 300 to analyze a single characteristic of the substance 202, or the weighting array 220 may be a dynamic weighting array and allow the device 300 to analyze multiple characteristics of the substance 202.

In operation, each light source element 302a-n may work in conjunction with the weighting array 220 such that the various weighted beams of modified electromagnetic radiation 240a-n are eventually generated and provided to the detector 216 for quantification. In some embodiments, for example, one or more of the light source elements 302a-n may be configured to apply a predetermined weighting factor to its corresponding beam of electromagnetic radiation 304a-n. In other embodiments, no determinable weighting factors are applied through the light source elements 302a-n. Rather, the weighting factors may be principally applied via the weighting array 220, as generally described above with reference to FIG. 2.

The array of light source elements 302a-n may prove advantageous in eliminating the need for collection and collimation optics (e.g., the first collimator 208, the expander 212, and the second collimator 214 of FIG. 2) and can thereby reduce the size of the device 300. Another advantage of the array of light source elements 302a-n is its ability to increase the light intensity and intensity profile transmitted into each element of the weighting array 220 and the processor array 222. This may help improve the performance of the device 300 by increasing the signal-to-noise ratio and sensitivity of the measurement.

In the illustrated embodiment, beams of electromagnetic radiation 304a-n may propagate toward and impinge upon the BASF array 218 prior to optically interacting with the weighting array 220 or the processor array 222. Electromagnetic radiation 304a-n propagating at the predetermined angle of incidence 224 may pass through the BASF array 218 as angle selective radiation 226a-n, while electromagnetic radiation 304a-n that impinges upon the BASF array 218 at any angle offset from the predetermined angle of incidence 224 may be reflected from the BASF array 218 as reflected radiation 228a-n. The BASF array 218 may, therefore, operate to allow only electromagnetic radiation 304a-n from an optically coupled light source element 302a-n to optically interact with correspondingly optically coupled weighting devices 234a-n and ICE cores 230a-n in optically interacting with the substance 202. As will be appreciated, this may reduce or eliminate optical cross-talk from non-coupled optical channels in the weighting array 220 and the processor array 222 as the electromagnetic radiation 304a-n propagates from the array of light source elements 302a-n to the detector 216.

As with prior embodiments, the BASF 218, the weighting array 220, and the processor array 220 may each be positioned at varying locations along the optical train, without departing from the scope of the disclosure. For instance, while FIG. 3 depicts the BASF array 218, the weighting array 220, and the processor array 222 in a particular linear combination within the optical train of the device 300, the position of any of the foregoing optical components may be switched or placed at any point along the optical train. In at least one embodiment, for instance, the processor array 222 may be arranged within the optical train following the light source 204 and prior to the BASF array 218. In other embodiments, the BASF array 218 may be positioned between or after both the weighting array 220 and the processor array 222. Those skilled in the art will recognize various optical configurations of device 300 are possible without departing from the scope of this disclosure.

Embodiments disclosed herein include:

A. An optical computing device that includes a light source that emits electromagnetic radiation into an optical train extending from the light source to a detector, a substance positioned in the optical train to optically interact with the electromagnetic radiation and produce sample interacted radiation, a processor array positioned in the optical train and including a plurality of integrated computational element (ICE) cores arranged on a substrate to optically interact with the electromagnetic radiation, wherein the detector receives a plurality of beams of modified electromagnetic radiation generated through optical interaction of the electromagnetic radiation with the substance and the processor array, a weighting array positioned in the optical train and including a plurality of weighting devices that optically apply corresponding weighting factors to each beam of modified electromagnetic radiation prior to detection with the detector, wherein each weighting device is optically aligned with a corresponding one of the plurality of ICE cores in the optical train, and a broadband angle selective filter (BASF) array positioned in the optical train and optically aligned with the processor array and the weighting array, wherein electromagnetic radiation impinging upon the BASF array at a predetermined angle of incidence is allowed to transmit through the BASF array, and electromagnetic radiation impinging upon the BASF array at an angle offset from the predetermined angle of incidence is prevented from transmitting through the BASF array, and wherein the detector generates an output signal indicative of a characteristic of the substance based on the plurality of beams of modified electromagnetic radiation.

B. A method that includes emitting electromagnetic radiation with a light source into an optical train that extends from the light source to a detector, optically interacting the electromagnetic radiation with a substance positioned in the optical train and thereby producing sample interacted radiation, optically interacting the electromagnetic radiation with a processor array positioned in the optical train, the processor array including a plurality of integrated computational element (ICE) cores arranged on a substrate, generating a plurality of beams of modified electromagnetic radiation through optical interaction of the electromagnetic radiation with the substance and the processor array, optically applying a weighting factor to each beam of modified electromagnetic radiation with a weighting array positioned in the optical train prior to detection with the detector, the weighting array including a plurality of weighting devices optically aligned with a corresponding one of the plurality of ICE cores in the optical train, reducing optical cross-talk with a broadband angle selective filter (BASF) array positioned in the optical train and optically aligned with the processor array and the weighting array, wherein electromagnetic radiation impinging upon the BASF array at a predetermined angle of incidence is allowed to transmit through the BASF array, and electromagnetic radiation impinging upon the BASF array at an angle offset from the predetermined angle of incidence is prevented from transmitting through the BASF array, and receiving the plurality of beams of modified electromagnetic radiation with the detector and generating an output signal indicative of a characteristic of the substance with the detector based on the plurality of beams of modified electromagnetic radiation.

Each of embodiments A and B may have one or more of the following additional elements in any combination: Element 1: wherein the BASF array comprises a plurality of layers of materials selected from the group consisting of quarter-wave heterostructures of photonic crystals and metamaterials. Element 2: wherein the BASF array is rotatable to selectively determine the predetermined angle of incidence. Element 3: wherein the weighting array forms an integral part of the processor array and each weighting device is coupled to the corresponding one of the plurality of ICE cores. Element 4: wherein the plurality of weighting devices are arranged on a substrate. Element 5: wherein one or more of the plurality of ICE cores is a frequency selective surface ICE core. Element 6: wherein the plurality of weighting devices comprises a weighting device selected from the group consisting of a neutral density filter, an optical iris, a pinhole, an aperture, an adjustable optical iris, a microelectromechanical systems (MEMS) mirror, a tunable Fabry-Perot etalon or cavity, a lithium niobate modulator, an acoustic tunable optical filter, and a liquid crystal tunable filter. Element 7: wherein the weighting array is a dynamic weighting array and one or more of the plurality of weighting devices is selectively tunable such that the corresponding weighting factor of the one or more of the plurality of weighting devices is variable. Element 8: wherein the weighting array is arranged on a movable assembly configured to allow each weighting device to optically interact with two or more of the plurality of ICE cores. Element 9: wherein the light source comprises a plurality of light source elements, each light source element being optically aligned with a corresponding one of the plurality of weighting devices and the corresponding one of the plurality of ICE cores in the optical train. Element 10: further comprising a signal processor that receives the output signal from the detector and determines the characteristic of the substance, the signal processor including a processor and a machine-readable storage medium having instructions stored thereon, which, when executed by the processor, cause the signal processor to determine the characteristic of the substance.

Element 11: wherein optically interacting the substance with the electromagnetic radiation comprises at least one of transmitting the electromagnetic radiation through the substance and reflecting the electromagnetic radiation off the substance. Element 12: wherein the BASF array comprises a plurality of layers of materials selected from the group consisting of quarter-wave heterostructures of photonic crystals and metamaterials. Element 13: further comprising rotating the BASF array to selectively determine the predetermined angle of incidence. Element 14: wherein the plurality of weighting devices comprises a weighting device selected from the group consisting of an adjustable optical iris, a microelectromechanical systems (MEMS) mirror, a tunable Fabry-Perot etalon or cavity, a lithium niobate modulator, an acoustic tunable optical filter, and a liquid crystal tunable filter, the method further comprising selectively tuning one or more of the plurality of weighting devices to vary a corresponding weighting factor, and receiving the plurality of beams of modified electromagnetic radiation with the detector and generating a second output signal indicative of a second characteristic of the substance with the detector based on the plurality of beams of modified electromagnetic radiation. Element 15: wherein the weighting array is arranged on a movable assembly, the method further comprising moving the movable assembly in the optical train, and optically interacting each weighting device with two or more of the plurality of ICE cores as the movable assembly moves. Element 16: wherein the weighting array is a first weighting array arranged on a movable assembly, the method further comprising optically interacting each weighting device of the first weighting array with a corresponding one of the plurality of beams of modified electromagnetic radiation, and thereby optically applying the corresponding weighting factors thereto, moving the movable assembly in the optical train such that a second weighting array arranged on the movable assembly is moved into the optical train, the second weighting array including a second plurality of weighting devices arranged on a second weighting substrate, and optically applying corresponding second weighting factors to each beam of modified electromagnetic radiation with the second plurality of weighting devices. Element 17: wherein a polarizing film is applied to one or more of the weighting devices, the method further comprising rotating a polarizer positioned in the optical train prior to the weighting array, and altering the corresponding weighting factors of the one or more of the weighting devices with the polarizer. Element 18: wherein the light source comprises a plurality of light source elements, the method further comprising generating a corresponding beam of electromagnetic radiation from each light source element, wherein each beam of electromagnetic radiation is optically aligned with a corresponding one of the plurality of weighting devices and the corresponding one of the ICE cores, and dynamically adjusting an intensity of at least one of the corresponding beams of electromagnetic radiation and thereby altering the weighting factor applied to one or more of the plurality of beams of modified electromagnetic radiation. Element 19: further comprising receiving the output signal from the detector with a signal processor, the signal processor including a processor and a machine-readable storage medium having instructions stored thereon, which, when executed by the processor, cause the signal processor to determine the characteristic of the substance, and determining the characteristic of the substance with the signal processor.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An optical computing device, comprising:
a light source that emits electromagnetic radiation into an optical train extending from the light source to a detector;
a substance positioned in the optical train to optically interact with the electromagnetic radiation and produce sample interacted radiation;
a processor array positioned in the optical train and including a plurality of integrated computational element (ICE) cores arranged on a substrate to optically interact with the electromagnetic radiation, wherein the detector receives a plurality of beams of modified electromagnetic radiation generated through optical interaction of the electromagnetic radiation with the substance and the processor array;
a weighting array positioned in the optical train and including a plurality of weighting devices that optically apply corresponding weighting factors to each beam of modified electromagnetic radiation prior to detection with the detector, wherein each weighting device is optically aligned with a corresponding one of the plurality of ICE cores in the optical train; and
a broadband angle selective filter (BASF) array positioned in the optical train and optically aligned with the processor array and the weighting array, wherein electromagnetic radiation impinging upon the BASF array at a predetermined angle of incidence is allowed to transmit through the BASF array, and electromagnetic radiation impinging upon the BASF array at an angle offset from the predetermined angle of incidence is prevented from transmitting through the BASF array, and
wherein the detector generates an output signal indicative of a characteristic of the substance based on the plurality of beams of modified electromagnetic radiation.

2. The device of claim 1, wherein the BASF array comprises a plurality of layers of materials selected from the group consisting of quarter-wave heterostructures of photonic crystals and metamaterials.

3. The device of claim 1, wherein the BASF array is rotatable to selectively determine the predetermined angle of incidence.

4. The device of claim 1, wherein the weighting array forms an integral part of the processor array and each weighting device is coupled to the corresponding one of the plurality of ICE cores.

5. The device of claim 1, wherein the plurality of weighting devices are arranged on a substrate.

6. The device of claim 1, wherein one or more of the plurality of ICE cores is a frequency selective surface ICE core.

7. The device of claim 1, wherein the plurality of weighting devices comprises a weighting device selected from the group consisting of a neutral density filter, an optical iris, a pinhole, an aperture, an adjustable optical iris, a microelectromechanical systems (MEMS) mirror, a tunable Fabry-Perot etalon or cavity, a lithium niobate modulator, an acoustic tunable optical filter, and a liquid crystal tunable filter.

8. The device of claim 1, wherein the weighting array is a dynamic weighting array and one or more of the plurality of weighting devices is selectively tunable such that the corresponding weighting factor of the one or more of the plurality of weighting devices is variable.

9. The device of claim 1, wherein the weighting array is arranged on a movable assembly configured to allow each weighting device to optically interact with two or more of the plurality of ICE cores.

10. The device of claim 1, wherein the light source comprises a plurality of light source elements, each light source element being optically aligned with a corresponding one of the plurality of weighting devices and the corresponding one of the plurality of ICE cores in the optical train.

11. The device of claim 1, further comprising a signal processor that receives the output signal from the detector and determines the characteristic of the substance, the signal processor including a processor and a machine-readable storage medium having instructions stored thereon, which, when executed by the processor, cause the signal processor to determine the characteristic of the substance.

12. A method, comprising:
emitting electromagnetic radiation with a light source into an optical train that extends from the light source to a detector;
optically interacting the electromagnetic radiation with a substance positioned in the optical train and thereby producing sample interacted radiation;
optically interacting the electromagnetic radiation with a processor array positioned in the optical train, the processor array including a plurality of integrated computational element (ICE) cores arranged on a substrate;
generating a plurality of beams of modified electromagnetic radiation through optical interaction of the electromagnetic radiation with the substance and the processor array;
optically applying a weighting factor to each beam of modified electromagnetic radiation with a weighting array positioned in the optical train prior to detection with the detector, the weighting array including a plurality of weighting devices optically aligned with a corresponding one of the plurality of ICE cores in the optical train;
reducing optical cross-talk with a broadband angle selective filter (BASF) array positioned in the optical train and optically aligned with the processor array and the weighting array, wherein electromagnetic radiation impinging upon the BASF array at a predetermined angle of incidence is allowed to transmit through the BASF array, and electromagnetic radiation impinging upon the BASF array at an angle offset from the predetermined angle of incidence is prevented from transmitting through the BASF array; and
receiving the plurality of beams of modified electromagnetic radiation with the detector and generating an output signal indicative of a characteristic of the substance with the detector based on the plurality of beams of modified electromagnetic radiation.

13. The method of claim 12, wherein optically interacting the substance with the electromagnetic radiation comprises at least one of transmitting the electromagnetic radiation through the substance and reflecting the electromagnetic radiation off the substance.

14. The method of claim 12, wherein the BASF array comprises a plurality of layers of materials selected from the group consisting of quarter-wave heterostructures of photonic crystals and metamaterials.

15. The method of claim 12, further comprising rotating the BASF array to selectively determine the predetermined angle of incidence.

16. The method of claim 12, wherein the plurality of weighting devices comprises a weighting device selected from the group consisting of an adjustable optical iris, a microelectromechanical systems (MEMS) mirror, a tunable Fabry-Perot etalon or cavity, a lithium niobate modulator, an acoustic tunable optical filter, and a liquid crystal tunable filter, the method further comprising:
selectively tuning one or more of the plurality of weighting devices to vary a corresponding weighting factor; and
receiving the plurality of beams of modified electromagnetic radiation with the detector and generating a second output signal indicative of a second characteristic of the substance with the detector based on the plurality of beams of modified electromagnetic radiation.

17. The method of claim 12, wherein the weighting array is arranged on a movable assembly, the method further comprising:
moving the movable assembly in the optical train; and
optically interacting each weighting device with two or more of the plurality of ICE cores as the movable assembly moves.

18. The method of claim 12, wherein the weighting array is a first weighting array arranged on a movable assembly, the method further comprising:
optically interacting each weighting device of the first weighting array with a corresponding one of the plurality of beams of modified electromagnetic radiation, and thereby optically applying the corresponding weighting factors thereto;
moving the movable assembly in the optical train such that a second weighting array arranged on the movable assembly is moved into the optical train, the second weighting array including a second plurality of weighting devices arranged on a second weighting substrate; and
optically applying corresponding second weighting factors to each beam of modified electromagnetic radiation with the second plurality of weighting devices.

19. The method of claim 12, wherein a polarizing film is applied to one or more of the weighting devices, the method further comprising:
rotating a polarizer positioned in the optical train prior to the weighting array; and
altering the corresponding weighting factors of the one or more of the weighting devices with the polarizer.

20. The method of claim 12, wherein the light source comprises a plurality of light source elements, the method further comprising:
generating a corresponding beam of electromagnetic radiation from each light source element, wherein each beam of electromagnetic radiation is optically aligned with a corresponding one of the plurality of weighting devices and the corresponding one of the ICE cores; and
dynamically adjusting an intensity of at least one of the corresponding beams of electromagnetic radiation and thereby altering the weighting factor applied to one or more of the plurality of beams of modified electromagnetic radiation.

21. The method of claim 12, further comprising:
receiving the output signal from the detector with a signal processor, the signal processor including a processor and a machine-readable storage medium having instructions stored thereon, which, when executed by the processor, cause the signal processor to determine the characteristic of the substance; and
determining the characteristic of the substance with the signal processor.
